(19) United States
(12) Patent Application Publication
(10) Pub. No.: US 2021/0286249 A1
(43) Pub. Date: Sep. 16, 2021

(54) PROJECTION-TYPE DISPLAY APPARATUS

(71) Applicant: SONY CORPORATION, Tokyo (JP)

(72) Inventors: YOSHIHISA SATO, SAITAMA (JP); HIROYUKI YANAGISAWA, KANAGAWA (JP)

(21) Appl. No.: 16/325,130

(22) PCT Filed: Jul. 27, 2017
(86) PCT No.: PCT/JP2017/027158

§ 371 Date: Feb. 12, 2019

(30) Foreign Application Priority Data
Sep. 6, 2016 (JP) 2016-173846

(51) Int. Cl. G03B 21/20; G03B 21/28; G02B 27/14; H04N 9/31

(52) U.S. Cl. CPC G03B 21/2073; G03B 21/204; G03B 21/28; H04N 9/3105; H04N 9/3167; H04N 9/3161; G02B 27/141

(57) ABSTRACT

A projection-type display apparatus including one or more light sources that emit pieces of light of first to third wavelength bands; first to third light modulation devices that modulate corresponding one of the pieces of light of the first to third wavelength bands; a color synthesis device that has a characteristic of reflecting or transmitting both S-polarized light and P-polarized light for the light of the first wavelength band, and reflecting the S-polarized light and transmitting the P-polarized light for the pieces of light of the second and third wavelength bands, and that synthesizes the pieces of light of the wavelength bands emitted from the first to third light modulation devices; and a projection optical system that projects the light synthesized by the color synthesis device, and full width at half maximum of a spectrum of the light of the first wavelength band that enters the color synthesis device is 40 nm or lower.

### TECHNICAL FIELD

The present technology relates to a projection-type display apparatus using a light modulation device such as a reflection-type light modulation device, for example.

### BACKGROUND ART

In recent years, a projector (projection-type display apparatus) using a reflection-type liquid crystal panel has been widespread as a large-screen image display apparatus because of its high resolution. The reflection-type liquid crystal panel is referred to as an LCOS (Liquid Crystal On Silicon), having a liquid crystal material provided on a silicon. For example, PTL 1 and PTL 2 disclose an optical system that uses the reflection-type liquid crystal panel and a polarizing beam splitter (polarization separation device).

### CITATION LIST

### Patent Literature

PTL 1: Japanese Unexamined Patent Application Publication No. 2001-154268

PTL 2: Japanese Unexamined Patent Application Publication No. 2006-84820

### SUMMARY OF THE INVENTION

In such an optical system using a light modulation device such as a reflection-type liquid crystal panel, suppression of a decrease in contrast is desired.

Therefore, it is desirable to provide a projection-type display apparatus that suppresses the decrease in contrast.

A projection-type display apparatus according to an embodiment of the present technology includes one or more light sources that emit pieces of light of first to third wavelength bands; first to third light modulation devices that modulate corresponding one of the pieces of light of the first to third wavelength bands; a color synthesis device that has a characteristic of reflecting or transmitting both S-polarized light and P-polarized light for the light of the first wavelength band, and reflecting the S-polarized light and transmitting the P-polarized light for the light of the second wavelength band and the light of the third wavelength band, and that synthesizes the pieces of light of the respective wavelength bands emitted from the first to third light modulation devices; and a projection optical system that projects light emitted from the color synthesis device, in which full width at half maximum of a spectrum of the light of the first wavelength band that enters the color synthesis device is 40 nm or lower.

In the projection-type display apparatus according to the embodiment of the present technology, the color synthesis device has the characteristic of reflecting or transmitting both the S-polarized light and the P-polarized light for the light of the first wavelength band, which thus makes it unnecessary to cause the light to pass through a wavelength selective phase difference plate, etc. before entering the color synthesis device. In addition, the full width at half maximum of the spectrum of the light of the first wavelength band that enters the color synthesis device is 40 nm or lower; that is, the light of the first wavelength band has a narrowband spectrum. Accordingly, the color synthesis device easily achieves the foregoing characteristic for the light of the first wavelength band in an efficient manner.

According to the projection-type display apparatus according to the embodiment of the present technology, it is unnecessary to cause the light to pass through the wavelength selective phase difference plate, etc., before entering the color synthesis device. In addition, the color synthesis device efficiently achieves the foregoing characteristic for the light of the first wavelength band, thus, making it possible to suppress the decrease in contrast. It is to be noted that the effects described above are not necessarily limited, and may be any of the effects that are described in the present disclosure.

### BRIEF DESCRIPTION OF DRAWINGS

FIG. 1 is a schematic view of a configuration of a projection-type display apparatus according to a first embodiment of the present technology.

FIG. 2 is a view of an example of a spectrum of light emitted from a light source illustrated in FIG. 1.

FIG. 3 is a side view of an example of a configuration of the light source illustrated in FIG. 1.

FIG. 4A is a view of a relation between a wavelength and a transmittance for S-polarized light of a color synthesis device illustrated in FIG. 1.

FIG. 4B is view of the relation between the wavelength and the transmittance for P-polarized light of the color synthesis device illustrated in FIG. 1.

FIG. 5 is an explanatory view of an operation of the projection-type display apparatus illustrated in FIG. 1.

FIG. 6 is a schematic view of a configuration of a projection-type display apparatus according to a comparative example.

FIG. 7 is a schematic view of a configuration of a projection-type display apparatus according to a modification example 1.

FIG. 8 is a schematic view of a configuration of a projection-type display apparatus according to a second embodiment.

FIG. 9 is a schematic view of a configuration of a projection-type display apparatus according to a modification example 2.

### MODES FOR CARRYING OUT THE INVENTION

In the following, some embodiments of the disclosure are described in detail with reference to the drawings. It is to be noted that description is given in the following order.

### 1. First Embodiment

Example in which a color synthesis device transmits S-polarized light and P-polarized light of a blue band

### 2. Modification Example 1

Example in which the color synthesis device reflects the S-polarized light and the P-polarized light of the blue band

### 3. Second Embodiment

Example in which the color separation device has two light-entering surfaces

### 4. Modification Example 2

Example in which light from a white light source is separated and guided to the two light-entering surfaces of the color separation device

### EMBODIMENTS

### (Configuration)

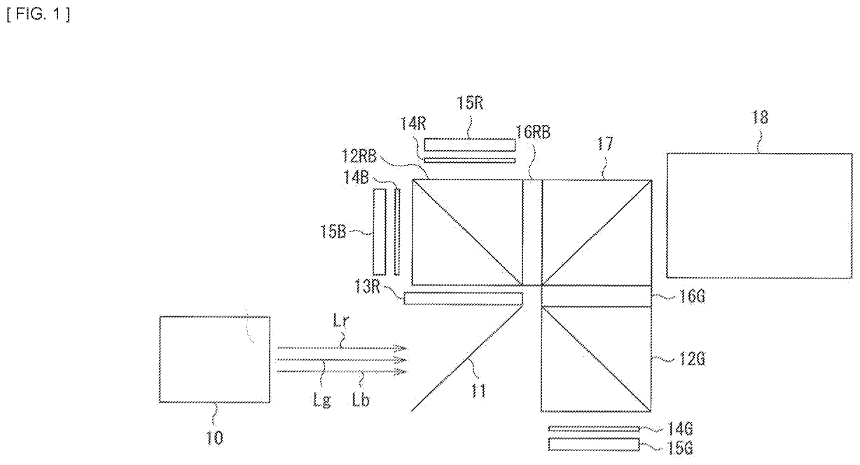

FIG. 1 is a schematic view of an overall configuration of a projection-type display apparatus (projection-type display apparatus 1) according to a first embodiment of the present technology. The projection-type display apparatus 1 is, for example, a display apparatus that projects an image on a screen. The projection-type display apparatus 1 is coupled to, for example, a computer such as a PC or an external image supply apparatus such as various types of image players via an I/F (interface), and performs projection onto the screen on the basis of an image signal inputted to the I/F. It is to be noted that the configuration of the projection-type display apparatus 1 to be described below is an example, and that the projection-type display apparatus of the present technology is not limited to such a configuration.

The projection-type display apparatus 1 includes a light source 10, and image light is generated by modulation of light (illuminating light) outputted from the light source 10 and synthesis of the light for each color of RGB. In addition to the light source 10, the projection-type display apparatus 1 includes a color separation device 11, polarization separation devices 12RB, 12G, a wavelength selective phase difference plate 13R, compensating plates 14R, 14B, and 14G, light modulation devices 15R, 15B, and 15G, phase difference plates 16RB and 16G, a color synthesis device 17, and a projection optical system 18.

The light source 10 is a light source that emits light including light of a red band (wavelength of approximately 590 nm to 630 nm), light of a green band (wavelength of approximately 500 nm to 580 nm), and light of blue band (wavelength of approximately 430 to 490). The light source 10 is a white light source that emits non-polarized white light, for example. Here, each of the blue band, the green band, and the red band corresponds to a specific example of a first wavelength band, a second wavelength band, and a third wavelength band of the present technology.

In the present embodiment, the light source 10 emits light having a blue band spectrum of full width at half maximum of 40 nm or lower. That is, the light source 10 emits the light having the blue band spectrum of a narrowband. The full width at half maximum of the blue band spectrum is preferably small and more preferably 10 nm or lower, for example.

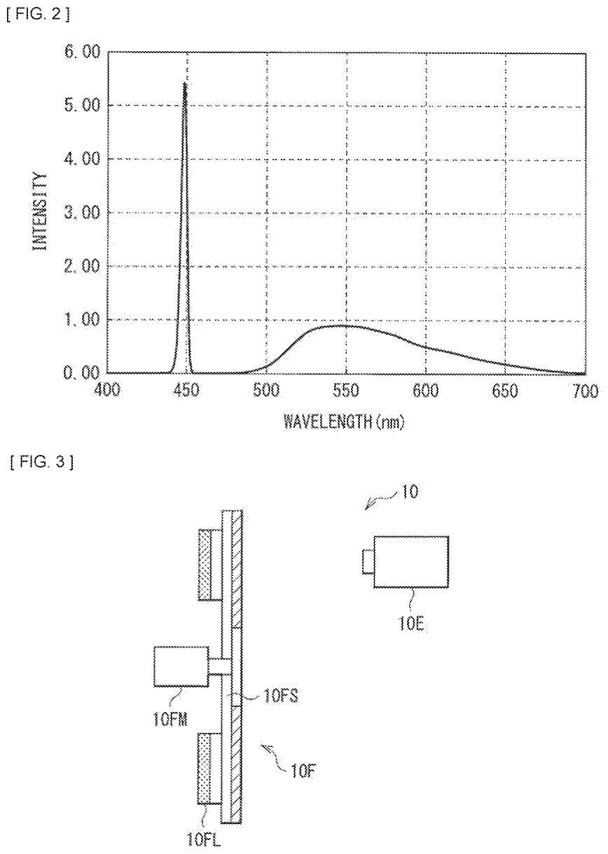

FIG. 2 is a view of an example of the spectrum of the white light emitted from the light source 10. A peak wavelength of the blue band of the white light is 445 nm, and the full width at half maximum of the peak is 4 nm.

FIG. 3 is a view of an example of a configuration of the light source 10 that generates such white light. The light source 10 has an excitation light source 10E and a fluorescent member 10F, for example. The fluorescent member 10F includes a motor 10FM and a florescent body layer 10FL on a substrate 10FS. The excitation light source 10E includes a laser that emits blue light having the wavelength of 445 nm, for example. The substrate 10FS is a disk-shaped transparent substrate made of glass or a transparent resin, etc., for example. The motor 10FM rotates the fluorescent member 10F at a predetermined rotation speed. This sequentially changes an illumination position of light from the excitation light source 10E in the fluorescent member 10F. The fluorescent body layer 10FL includes a YAG (Yttrium Aluminum Garnet)-based fluorescent material, etc., for example. The fluorescent body layer 10FL transmits a portion of excitation light from the excitation light source 10E and absorbs the remaining excitation light. The excitation light absorbed by the fluorescent body layer 10FL excites the fluorescent body layer 10FL. This emits yellow light from the fluorescent body layer 10FL. The yellow light and the blue light that passes through the fluorescent body layer 10FL are synthesized, and thereby the white light is emitted from the light source 10. For the configuration of the light source 10, although it is possible to refer to a description of Japanese Unexamined Patent Application Publication No. 2012-3923, the light source 10 may have other configuration.

The light emitted from the light source 10 passes through an unillustrated illumination optical system and is guided from the illumination optical system to the color separation device 11. The illumination optical system includes a lens group and a polarization conversion device, for example, and a polarization direction of the light generated in the light source 10 is aligned. The light passing through the illumination optical system is light of the S-polarized light, for example, and includes red light, green light, and blue light of the S-polarized light.

The color separation device 11 includes a dichroic mirror or a dichroic prism, for example. The color separation device 11 reflects the red light and the blue light, for example, to guide them to the polarization separation device 12RB and transmits the green light to guide it to the polarization separation device 12G.

The wavelength selective phase difference plate 13R is disposed on an optical path between the color separation device 11 and the polarization separation device 12RB. The wavelength selective phase difference plate 13R has a characteristic that the polarization direction rotates only in a selective wavelength band. The wavelength selective phase difference plate 13R is configured to, of light of the red band and light of the blue band, for example, selectively rotate the polarization direction of the light of the red band 90 degrees and transmit the light of the blue band while maintaining the polarization direction. That is, the wavelength selective phase difference plate 13R selectively functions as a half-wavelength plate for the light of the red band, for example, and the red light becomes the P-polarized light by means of the wavelength selective phase difference plate 13R. It is sufficient if the wavelength selective phase difference plate 13R is designed only in consideration of performance in bands (here, the red band and the blue band) of at least two wavelengths, and it is unnecessary to consider all wavelengths of the RGB (the characteristic of the green band is optional).

The polarization separation devices 12RB and 12G guide the light of the respective red band, green band, and blue band to the corresponding light modulation devices 15R, 15B, and 15G, and guide the modulated light to the color synthesis device 17. The polarization separation devices 12RB and 12G include a polarizing beam splitter, for example. The polarization separation devices 12RB and 12G may be other optical device as far as it is a device that is able to separate a polarization component, and may be a wire grid polarization device, etc., for example.

The polarization separation device 12RB (first polarization separation device) guides, for example, the red light and the blue light respectively to the light modulation device 15R and the light modulation device 15B, and also guides the modulated red light and the modulated blue light to the color synthesis device 17. The polarization separation device 12G (second polarization separation device) guides, for example, the green light to the light modulation device 15G, and also guides the modulated green light to the color synthesis device 17.

The light modulation devices 15R, 15G, and 15B are reflection-type modulation devices and include a reflection-type liquid crystal panel, for example. It is possible to use a liquid crystal device such as an LCOS, for example, for the reflection-type liquid crystal panel. The light modulation device 15R performs spatial modulation of the red light guided from the polarization separation device 12RB, the light modulation device 15B performs the spatial modulation of the blue light guided from the polarization separation device 12RB, and the light modulation device 15G performs the spatial modulation of the green light guided from the polarization separation device 12G.

The compensating plate 14R, the compensating plate 14B, and the compensating plate 14G are respectively provided on the optical path between the polarization separation device 12RB and the light modulation device 15R, between the polarization separation device 12RB and the light modulation device 15B, and between the polarization separation device 12G and the light modulation device 15G. The compensating plates 14R, 14G, and 14B are optical compensating plates, and provided to correct a pre-tilt angle of a liquid crystal formed of the reflection-type liquid crystal panel that the light modulation devices 15R, 15G, and 15G have, and a screw ray of a light beam, for example.

The phase difference plate 16RB (first phase difference plate) is disposed on the optical path between the polarization separation device 12RB and the color synthesis device 17, and the phase difference plate 16G (second phase difference plate) is disposed on the optical path between the polarization separation device 12G and the color synthesis device 17. The phase difference plates 16RB and 16RG are devices to rotate the polarization direction of incoming light. Here, the phase difference plates 16RB and 16G are the half-wavelength plates and rotate the polarization direction of the incoming light 90 degrees.

The color synthesis device 17 is a device that synthesizes (color-synthesizes) the light of the respective wavelength bands emitted from the respective light modulation devices 15R, 15G, and 15B and guides the light to the projection optical system 18. In the present embodiment, the color synthesis device 17 has the characteristic of transmitting both the S-polarized light and the P-polarized light for the light of the blue band, and of reflecting the S-polarized light and transmitting the P-polarized light for the light of the red band and the light of the green band. That is, the color synthesis device 17 functions as the optical device that separates the polarization components for the light of the red band and the light of the green band, among the light of the red band, the light of the green band, and the light of the green band. Details are to be described later. However, with this, the wavelength selective phase difference plate on the optical path between the polarization separation device 12RB and the color synthesis device 17 becomes unnecessary, thus making it possible to suppress the decrease in contrast.

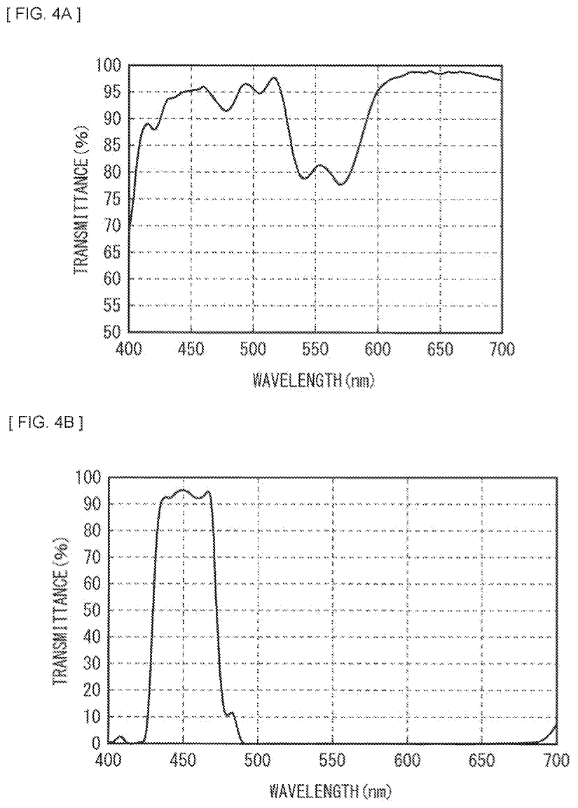

FIGS. 4A and 4B illustrate optical characteristics of the color synthesis device 17. FIG. 4A illustrates a transmittance for the P-polarized light, and FIG. 4B illustrates the transmittance for the S-polarized light. For the P-polarized light, the high transmittance is exhibited for all of the wavelength bands of the red band, the green band and the blue band. For the S-polarized light, only the light of the blue band is transmitted, and the light of the red band and the light of the green band are reflected. It is to be noted that, although the transmittance of the P-polarized light of the green band is relatively low, this does not affect brightness. This is because the S-polarized light of the green band enters the color synthesis device 17, as described later. Such a color synthesis device 17 includes a device obtained by vapor depositing a thin film, using a glass material with a low photoelastic coefficient such as PHB56 or SF9, for example.

### (Operation)

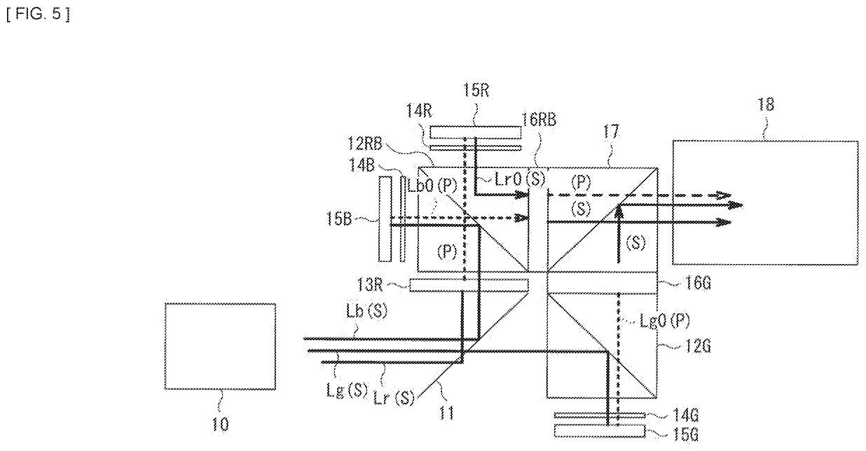

In the following, description is given of an operation of the projection-type display apparatus 1 of the present embodiment with reference to FIG. 5. Once the white light is emitted from the light source 10, the polarization direction is set by the unillustrated illumination optical system, and the white light becomes light including the light of the red band (red light Lr(s)), the light of the green band (green light Lg(s)), and the light of the blue band (blue light Lb(s)) of the S-polarized light and enters the color separation device 11. The red light Lr(s) and the blue light Lb(s) are reflected by the color separation device 11 and enter the polarization separation device 12RB via the wavelength selective phase difference plate 13R. In the wavelength selective phase difference plate 13R, only the polarization direction of the red light Lr(s) is rotated, and thus red light Lr(p) of the P-polarized light and the blue light Lb(s) of the S-polarized light enter the polarization separation device 12RB. The red light Lr(p) is transmitted through the polarization separation device 12RB and enters the light modulation device 15R. The blue light Lb(s) is reflected by the polarization separation device 12RB and enters the light modulation device 15B. On the one hand, the green light Lg(s) that is transmitted through the color separation device 11 enters the polarization separation device 12G, is reflected by the polarization separation device 12G, and enters the light modulation device 15G.

The light modulation devices 15R, 15G, and 15B perform the spatial modulation of the light of the respective wavelength bands in accordance with an image signal inputted externally. Now, the polarization direction of the light subjected to the spatial modulation (ON-light) is rotated. Specifically, the red light Lr(p) of the P-polarized light is modulated by the light modulation device 15R, and red light Lr0(s) of the S-polarized light enters the polarization separation device 12RB. Similarly, the blue light Lb(s) and the green light Lg(s) of the S-polarized light are modulated by the light modulation devices 15B and 15G, and blue light Lb0(p) and green light Lg0(p) of the P-polarized light respectively enter the polarization separation devices 12RB and 12G. OFF-light of the light of each wavelength band proceeds to the light source 10 via the polarization separation devices 12RB and 12G, while maintaining the polarization direction.

The red light Lr0(s) and the blue light Lb0(p) that enter the polarization separation device 12RB go through the phase difference plate 16RB and enter the color synthesis device 17. Specifically, the red light Lr0(s) is reflected by the polarization separation device 12RB, and the blue light Lb0(p) is transmitted through the polarization separation device 12RB and enters the phase difference plate 16RB. In the phase difference plate 16RB, the polarization direction is rotated, and red light Lr0(p) of the P-polarized light and blue light Lb0(s) of the S-polarized light enter the color synthesis device 17. The full width at half maximum of the spectrum of the light of the blue band emitted from the light source 10 is 40 nm or lower, and thus, the full width at half maximum of the spectrum of the blue light Lb0(s) entering the color synthesis device 17 is also 40 nm or lower.

On the one hand, the green light Lg0(p) that enters the polarization separation device 12G goes through the phase difference plate 16G and enters the color synthesis device 17. Specifically, the green light Lg0(p) is transmitted through the polarization separation device 12G and enters the phase difference plate 16G. In the phase difference plate 16G, the polarization direction is rotated, and green light Lg0(s) of the S-polarized light enters the color synthesis device 17.

In the color synthesis device 17, the light of the respective wavelength bands after modulation is synthesized and guided to the projection optical system 18. Here, the color synthesis device 17 functions as the optical device that separates polarized light for the red light Lr0(p) and the green light Lg0(s). Thus, the red light Lr0(p) is transmitted through the color synthesis device 17 and the green light Lg0(s) is reflected by the color synthesis device 17. The blue light Lb0(s) is transmitted through the color synthesis device 17. In this manner, the red light Lr0(p), the green light Lg0(s), and the blue light Lb0(s) that enter the color synthesis device 17 are synthesized and guided to the projection optical system 18. This causes the synthesized light to be expanded and projected on the screen, achieving display.

### (Workings and Effects)

In the projection-type display apparatus 1 of the present embodiment, the color synthesis device 17 has the characteristic of transmitting both the S-polarized light and the P-polarized light for the light of the blue band, thus making it unnecessary to cause the light to pass through the wavelength selective phase difference plate, etc., before entering the color synthesis device 17. This makes it possible to suppress the decrease in contrast, which is described in the following.

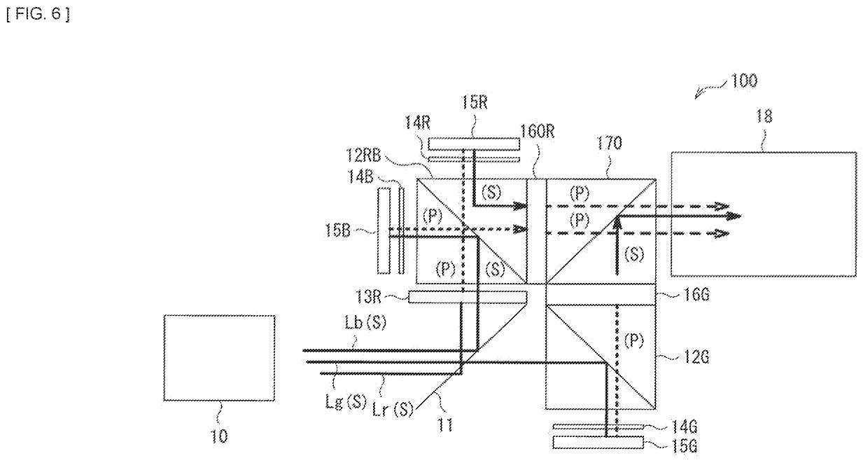

FIG. 6 schematically illustrates a configuration of a projection-type display apparatus (projection-type display apparatus 100) according to a comparative example. A color synthesis device 170 of the projection-type display apparatus 100 includes the polarizing beam splitter, for example. The color synthesis device 170 transmits the P-polarized light for all of the wavelength bands of the red band, the green band, and the blue band and reflects the S-polarized light. Accordingly, a wavelength selective phase difference plate 160R is necessary on the optical path between the polarization separation device 12RB and the color synthesis device 170 in order to synthesize the light entering the color synthesis device 170 and guide the light to the projection optical system 18. The wavelength selective phase difference plate 160R is configured to, of the light of the red band and the light of the blue band, selectively rotate the polarization direction of the light of the red band and transmit the light of the blue band while maintaining the polarization direction.

In addition, for the projection-type display apparatus 100, similarly to the foregoing projection-type display apparatus 1, the light of the red band and the light of the blue band are respectively modulated by the light modulation devices 15R and 15B. The red light of the S-polarized light modulated by the light modulation device 15R and the blue light of the P-polarized light modulated by the light modulation device 15B go through the wavelength selective phase difference plate 160R and enter the color synthesis device 170. In the wavelength selective phase difference plate 160R, only the polarization direction of the entering red light is rotated. That is, the red light and the blue light of the P-polarized light enter the color synthesis device 170 from the wavelength selective phase difference plate 160R. The color synthesis device 170 transmits the red light and the blue light of the P-polarized light and reflects the green light of the S-polarized light. Thereafter, the color synthesis device 170 synthesizes and guides these pieces of light to the projection optical system 18. This causes the image to be displayed on the screen, etc.

Due to manufacturing variation, however, the wavelength selective phase difference plate 160R may also rotate the polarization direction of light other than the light of the red band. In a case where the wavelength selective phase difference plate 160R also rotates the polarization direction of, for example, the light of the blue band, other than the red band, this results in the decrease in contrast of a projected image.

In addition, in order to prevent such a decrease in contrast, although a method of disposing a polarizing plate between the polarization separation device 12RB and the color synthesis device 170 may be assumed, the contrast may decrease in this case, too, due to light absorption at the polarizing plate. In a case where the polarizing plate absorbs light, the polarizing plate generates heat and temperature inside the polarization separation device 12RB disposed adjacent to the polarizing plate rises. The polarization separation device 12RB includes glass, for example, and the temperature rise generates stress within the polarization separation device 12RB. The stress generates double refraction, resulting in elliptic polarization, and thus the contrast of the projected image decreases.

In contrast, in the present embodiment, the color synthesis device 17 has the characteristic of transmitting both the S-polarized light and the P-polarized light for the light of the blue band. Accordingly, it is possible to guide the light of the red wavelength band and the light of the blue wavelength band from the polarization separation device 12RB to the color synthesis device 17, without providing the wavelength selective phase difference plate (wavelength selective phase difference plate 160R of FIG. 6, for example) on the optical path between the polarization separation device 12RB and the color synthesis device 17. Therefore, it is possible to suppress the decrease in contrast due to the manufacturing variation of the wavelength selective phase difference plate. In addition, the polarizing plate adjacent to the polarization separation device 12RB is unnecessary, thus making it possible to suppress the decrease in contrast due to the light absorption of the polarizing plate. It is to be noted that the phase difference plates 16RB and 16G absorb little light and generate substantially no heat.

Furthermore, the full width at half maximum of the spectrum of the light of the blue band emitted from the light source 10 is 40 nm or lower, and the full width at half maximum of the spectrum of the light of the blue band (blue light Lb0(s)) entering the color synthesis device 17 is also 40 nm or lower. That is, the light of the blue band entering the color synthesis device 17 has the narrowband spectrum. Thus, in the color synthesis device 17, a wavelength range where a characteristic of the foregoing blue band is efficiently achieved easily matches the wavelength range of the light of the blue band entering the color synthesis device 17, and the blue light Lb0(s) efficiently enters the projection optical system 18 from the color synthesis device 17. Therefore, it is also possible to suppress the decrease in contrast due to the characteristic of the color synthesis device 17.

As described above, in the present embodiment, the color synthesis device 17 has the characteristic of transmitting both the S-polarized light and the P-polarized light for the light of the blue band, thus making it unnecessary to cause the light to pass through the wavelength selective phase difference plate and the polarizing plate before entering the color synthesis device 17. In addition, the light of the blue band entering the color synthesis device 17 has the narrowband spectrum. This makes it possible to suppress the decrease in contrast.

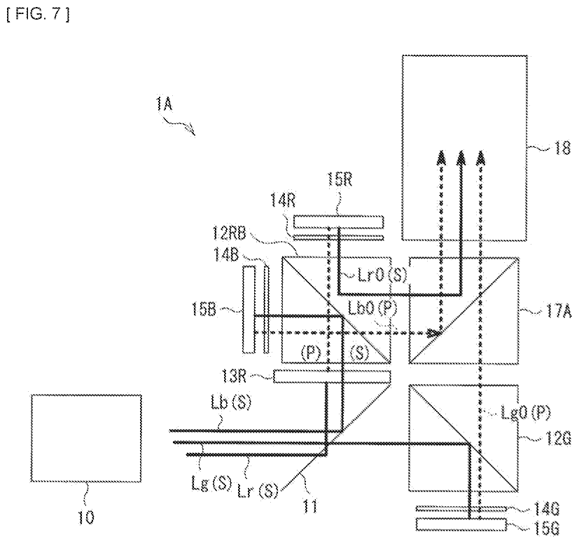

Furthermore, the projection-type display apparatus 1 is configured to cause the light of the red band and the light of the blue band modulated by the light modulation devices 15R and 15B to be transmitted through the color synthesis device 17 and enter the projection optical system 18. This makes it possible to set a larger distance between the light modulation devices 15R and 15B and the projection optical system 18 than a case where the projection-type display apparatus is configured to cause the light of the red band and the light of the blue band modulated by the light modulation devices 15R and 15B to be reflected by the color synthesis device 17 and enter the projection optical system 18 (FIG. 7 to be described later, for example). Therefore, around the light modulation devices 15R and 15B is secured a space enough to fix the light modulation devices 15R and 15G, thus making it possible to firmly fix the light modulation devices 15R and 15B to improve reliability of the projection-type display apparatus 1.

Next, description is given of a modification example of the foregoing embodiment and other embodiments. In the following, same components as those of the foregoing first embodiment are denoted by same reference numerals, and description thereof is omitted where appropriate.

### Modification Example 1

FIG. 7 schematically illustrates an overall configuration of a projection-type display apparatus (projection-type display apparatus 1A) according to the modification example 1. The projection-type display apparatus 1A includes a color synthesis device 17A, instead of the color synthesis device 17 of the foregoing first embodiment. The color synthesis device 17A has the characteristic of reflecting both the S-polarized light and the P-polarized light for the light of the blue band. The projection-type display apparatus 1A differs from the projection-type display apparatus 1 in this respect.

The color synthesis device 17A has the characteristic of reflecting the S-polarized light and transmitting the P-polarized light for the light of the red band and the light of the green band, similarly to the color synthesis device 17. Similarly to the projection-type display apparatus 1, the light of the respective wavelength bands is modulated by the light modulation devices 15R, 15G, and 15B, and enters the polarization separation devices 12RB and 12G. In the projection-type display apparatus 1A, the red light Lr0(s), the green light Lg0(p), and the blue light Lb0(p) after modulation enter the color synthesis device 17A from the polarization separation devices 12RB and 12G without going through the phase difference plate (phase difference plates 16RB and 16G of FIG. 1, for example). The red light Lr0(s) and the blue light Lb0(p) are reflected by the color synthesis device 17A, and the green light Lg0(p) is transmitted through the color synthesis device 17A. In this manner, the red light Lr0(s), the green light Lg0(p), and the blue light Lb0(p) that enter the color synthesis device 17A are synthesized and guided to the projection optical system 18.

Similarly to the foregoing projection-type display apparatus 1, it is unnecessary for such a projection-type display apparatus 1A to have the wavelength selective phase difference plate and the polarizing plate, thus making it possible to suppress the decrease in contrast. Additionally, the phase difference plate on the optical path between the polarization separation devices 12RB and 12G and the color synthesis device 17A is unnecessary, thus making it possible to suppress the decrease in contrast with a simpler configuration.

### Second Embodiment

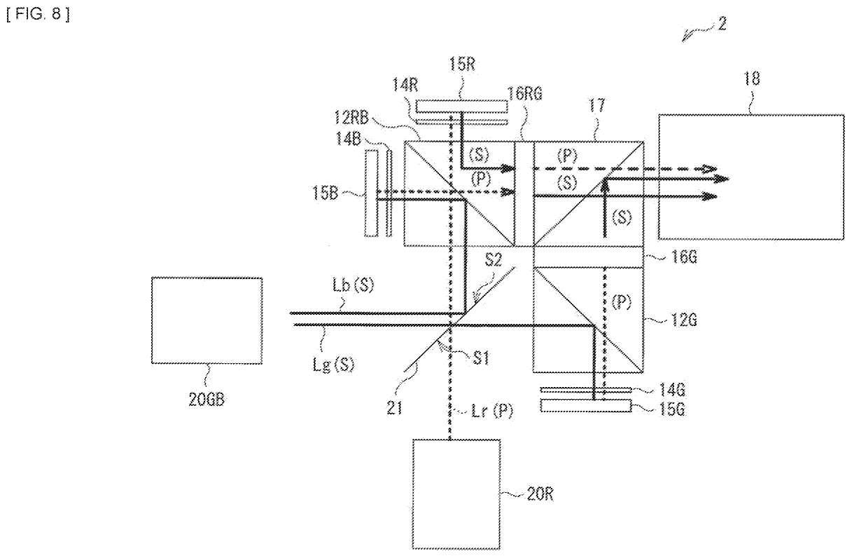

FIG. 8 schematically illustrates a configuration of a projection-type display apparatus (projection-type display apparatus 2) according to a second embodiment. The projection-type display apparatus 2 includes a color separation device 21 instead of the color separation device 11 of the foregoing first embodiment. The color separation device 21 includes two light-entering surfaces (light-entering surfaces S1 and S2). The projection-type display apparatus 2 differs from the projection-type display apparatus 1 in this respect.

Two light sources (light sources 20R and 20GB) are provided in the projection-type display apparatus 2. The light source 20R emits the light of the red band, and the light source 20BG emits the light of the green band and the light of the blue band. The configuration is such that the light of the red band emitted from the light source 20R enters the light-entering surface 51 of the color separation device 21 and the light of the green band and the light of the blue band emitted from the light source 20GB enter the light-entering surface S2 of the color separation device 21. The unillustrated illustration optical system provided on the optical path between the light source 20R and the color separation device 21 aligns the polarization direction of the light of the red band emitted from the light source 20R to be in a direction of the P-polarized light, and guides the light of the red band to the color separation device 21. The unillustrated illumination optical system provided on the optical path between the light source 20GB and the color separation device 21 aligns the polarization direction of the light of the green band and the light of the blue band emitted from the light source 20GB to be in a direction of the S-polarized light and guides the light of the green band and the light of the blue band to the color separation device 21. A traveling direction of the red light (red light Lr(p)) of the P-polarized light entering the light-entering surface S1 and the traveling direction of the green light (green light Lg(s)) and the blue light (blue light Lb(s)) of the S-polarized light entering the light-entering surface S2 are orthogonal to each other, for example.

The color separation device 21 includes the dichroic mirror or the dichroic prism, for example. The color separation device 21 guides to the polarization separation device 12RB the red light Lr(p) entering the light-entering surface S1 and the blue light Lb(s) entering the light-entering surface S2, and guides the green light Lg(s) entering the light-entering surface S2 to the polarization separation device 12G.

The light of the red band emitted from the light source 20R goes through the unillustrated illumination optical system and becomes the red light Lr(p) of the P-polarized light. The red light Lr(p) enters the light-entering surface S1 of the color separation device 21. The red light Lr(p) is transmitted through the color separation device 21 and enters the polarization separation device 12RB. On the one hand, the light of the green band and the light of the blue band emitted from the light source 20GB go through the unillustrated illumination optical system and becomes the green light Lg(s) and the blue light Lb(s) of the S-polarized light. The green light Lg(s) and the blue light Lb(s) enter the light-entering surface S2 of the color separation device 21. The green light Lg(s) is transmitted through the color separation device 21 and enters the polarization separation device 12G. The blue light Lb(s) is reflected by the color separation device 21 and enters the polarization separation device 12RB.

In this manner, in the projection-type display apparatus 2, the color separation device 21 includes the two light-entering surfaces S1 and S2, thus making it possible to cause pieces of light (red light Lr(p) and the blue light Lb(s)) having the polarization directions being orthogonal to each other, to enter the polarization separation device 12RB from the different light-entering surfaces. That is, the wavelength selective phase difference plate (wavelength selective phase difference plate 13R of FIG. 1, for example) between the color separation device 21 and the polarization separation device 12RB becomes unnecessary.

In such a projection-type display apparatus 2, similarly to the foregoing projection-type display apparatus 1, the wavelength selective phase difference plate (wavelength selective phase difference plate 160 of FIG. 6, for example) and the polarizing plate are unnecessary, thus making it possible to suppress the decrease in contrast. Additionally, the wavelength selective phase difference plate on the optical plate between the color separation device and the polarization separation device is also unnecessary, thus making it possible to suppress the decrease in contrast more effectively. In addition, in such a projection-type display apparatus 2, it is possible to configure an optical device other than the light modulation devices 15R, 15G, and 15B with an inorganic material, which makes resistance to the temperature rise stronger and allows for further suppression of the decrease in contrast.

### Modification Example 2

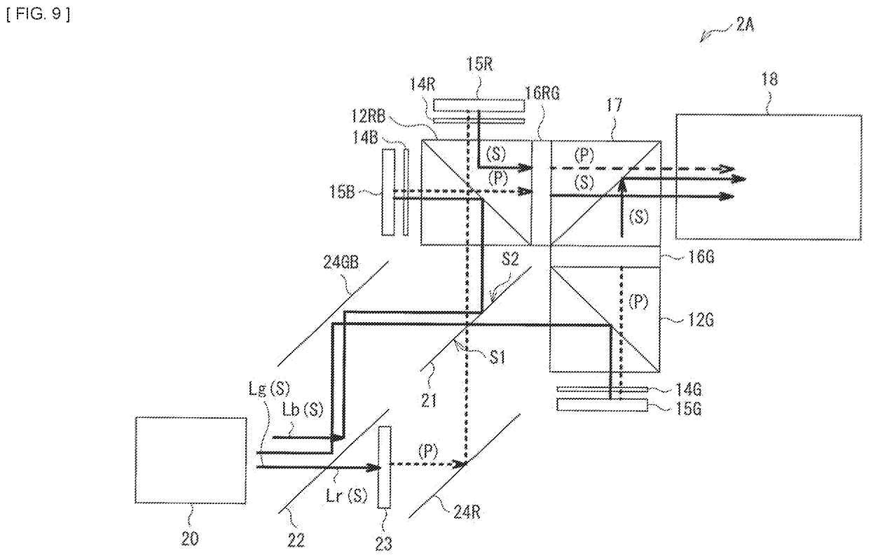

FIG. 9 schematically illustrates a configuration of a projection-type display apparatus (projection-type display apparatus 2A) according to a modification example 2. The projection-type display apparatus 2A includes a light source (light source 20) that emits the white light, instead of the two light sources (light sources 20R and 20GB) of the foregoing second embodiment. The projection-type display apparatus 2A differs from the projection-type display apparatus 2 in this respect.

The projection-type display apparatus 2A includes a color separation device 22 on the optical path of the white light emitted from the light source 20, and the color separation device 22 separates the white light into the red light (red light Lr(s) to be described later), the green light (green light Lg(s) to be described later), and the blue light (blue light Lb(s) to be described later). The color separation device 22 includes the dichroic mirror or the dichroic prism, for example. A phase difference plate 23 and an optical path conversion device 24R are provided on the optical path of the red light between the color separation device 22 and the light-entering surface Si of the color separation device 21, and an optical path conversion device 24GB is provided on the optical path of the green light and the blue light between the color separation device 22 and the light-entering surface S2 of the color separation device 21. The phase difference plate 23 is the half-wavelength plate. The optical path conversion device 24R guides the red light to the light-entering surface S1 of the color separation device 21, and the optical path conversion device 24GB guides the green light and the blue light to the light-entering surface S2 of the color separation device 21. The optical path conversion devices 24R and 24GB are configured by a mirror, etc., for example.

The white light emitted from the light source 20 goes through the unillustrated illustration optical system to have the polarization direction aligned. The white light becomes the light including the red light Lr(s), the green light Lg(s), and the blue light Lb(s) of the S-polarized light and enters the color separation device 22. The red light Lr(s) is transmitted through the color separation device 22 and enters the phase difference plate 23. In the phase difference plate 23, the polarization direction is rotated 90 degrees. Thus, the red light Lr(p) of the P-polarized light goes through the optical path conversion device 24R and enters the light-entering surface S1 of the color separation device 21. In contrast, after being reflected by the color separation device 22, the green light Lg(s) and the blue light Lb(s) go through the optical path conversion device 24GB while maintaining the polarization direction and enter the light-entering surface S2 of the color separation device 21.

In this manner, the projection-type display apparatus 2A uses the one light source 20, and thus is able to reduce a heat generation unit by the light source, as compared with a case where a plurality of light sources is used. Therefore, it is possible to easily prevent heat generation of the optical system.

In such a projection-type display apparatus 2A, similarly to the foregoing projection-type display apparatus 2, the wavelength selective phase difference plate on the optical path between the color separation device and the polarization separation device is unnecessary, thus making it possible to suppress the decrease in contrast more effectively. Additionally, it is possible to prevent the heat generation resulting from the light source and further suppress the decrease in contrast.

Although the description has been given of the present technology with reference to the foregoing embodiments and modification examples, the present technology is not limited to the foregoing embodiments, etc., and may be modified in a variety of ways. For example, the components, layout, and numbers, etc. of an optical unit exemplified in the foregoing embodiments are merely illustrative, and the optical unit does not necessarily include all of the components and may also include other components, too.

In addition, although the foregoing embodiments, etc., illustrate the red band, the green band, and the blue band as the first to third wavelength bands, a portion thereof may be other wavelength band. Moreover, light of other wavelength band such as a near-infrared band may also be used as a fourth wavelength band as well as the three wavelength bands.

Furthermore, although FIG. 8 and FIG. 9 illustrate the case where the color synthesis device 17 is used, the color synthesis device 17A instead of the color synthesis device 17 may be disposed in FIG. 8 and FIG. 9. That is, the color separation device 21 and the color synthesis device 17A may be combined.

Furthermore, although in the foregoing embodiments, etc., description has been given of a case where the light of the blue band having the full width at half maximum of 40 nm or lower is emitted from the light source, the light of the blue band may be converted into light having the narrowband spectrum after being emitted from the light source and before entering the color synthesis device.

It is to be noted that the effects described herein are merely illustrative and not limited thereto, and may further include other effects.

Moreover, the present technology may have the following configurations.

(1) A projection-type display apparatus including:
one or more light sources that emit pieces of light of first to third wavelength bands;
first to third light modulation devices that modulate corresponding one of the pieces of light of the first to third wavelength bands;
a color synthesis device that has a characteristic of reflecting or transmitting both S-polarized light and P-polarized light for the light of the first wavelength band, and reflecting the S-polarized light and transmitting the P-polarized light for the light of the second wavelength band and the light of the third wavelength band, and that synthesizes the pieces of light of the wavelength bands emitted from the first to third light modulation devices; and
a projection optical system that projects the light synthesized by the color synthesis device, in which
full width at half maximum of a spectrum of the light of the first wavelength band that enters the color synthesis device is 40 nm or lower.

(2) The projection-type display apparatus according to (1), further including:
a first polarization separation device that allows the pieces of light of the two wavelength
bands of the first to third wavelength bands to enter, and that guides each of the pieces of light of the two wavelength bands to corresponding one of the first to third light modulation devices; and a second polarization separation device that allows the piece of light of the other one wavelength band of the first to third wavelength bands to enter, and that guides the piece of light of the one wavelength band to corresponding one of the first to third light modulation devices.

(3) The projection-type display apparatus according to (2), in which the light of the first wavelength band and the light of the third wavelength band enter the first polarization separation device, and the light of the second wavelength band enters the second polarization separation device.

(4) The projection-type display apparatus according to (3), in which
the first polarization separation device guides to the color synthesis device the light modulated by the first and third light modulation devices, and
the second polarization separation device guides to the color separation device the light modulated by the second light modulation device.

(5) The projection-type display apparatus according to (4), further including:
a first phase difference plate provided on an optical path between the first polarization separation device and the color synthesis device: and
a second phase difference plate provided on an optical path between the second polarization separation device and the color synthesis device.

(6) The projection-type display apparatus according to (4), in which no polarizing plate and wavelength selective phase difference plate are provided between the first polarization separation device and the color synthesis device and between the second polarization separation device and the color synthesis device.

(7) The projection-type display apparatus according to (4), further including:
a color separation device that allows the pieces of light of the first to third wavelength bands emitted from the light source to enter, and that guides the pieces of light of the first wavelength band and of the third wavelength band to the first polarization separation device and guides the piece of light of the second wavelength band to the second polarization separation device.

(8) The projection-type display apparatus according to (7), further including:
a wavelength selective phase difference plate between the color separation device and the first polarization separation device, the wavelength selective phase difference plate selectively functioning on the light of the third wavelength band, of the pieces of light of the first wavelength band and the third wavelength band.

(9) The projection-type display apparatus according to (7), in which the color separation device includes a first light-entering surface that allows the piece of light of the third wavelength band to enter and a second light-entering surface that allows the pieces of light of the first wavelength band and the second wavelength band to enter.

(10) The projection-type display apparatus according to (9), in which the P-polarized light of the third wavelength band enters the first light-entering surface, and the S-polarized light of the piece of light of the first wavelength band enters the second light-entering surface.

(11) The projection-type display apparatus according to any one of (1) to (10), in which the color synthesis device has the characteristic of transmitting both the S-polarized light and the P-polarized light for the piece of light of the first wavelength band.

(12) The projection-type display apparatus according to any one of (1) to (10), in which the color synthesis device has the characteristic of reflecting both the S-polarized light and the P-polarized light for the light of the first wavelength band.

(13) The projection-type display apparatus according to any one of (1) to (12) including the one light source.

(14) The projection-type display apparatus according to (13), in which the one light source emits white light.

(15) The projection-type display apparatus according to any one of (1) to (14), in which the first wavelength band is a blue band, the second wavelength band is a green band, and the third wavelength band is a red band.

(16) The projection-type display apparatus according to any one of (1) to (15), in which the first to third light modulation devices are reflective-type light modulation devices.

This application claims the benefits of Japanese Priority Patent Application No. 2016-173846 filed with the Japan Patent Office on Sep. 6, 2016, the entire content of which is incorporated herein by reference.

It should be understood that those skilled in the art could conceive various modifications, combinations, sub-combinations, and alterations depending on design requirements and other factors, insofar as they are within the scope of the appended claims or the equivalents thereof.

1. A projection-type display apparatus comprising:
one or more light sources that emit pieces of light of first to third wavelength bands;
first to third light modulation devices that modulate corresponding one of the pieces of light of the first to third wavelength bands;
a color synthesis device that has a characteristic of reflecting or transmitting both S-polarized light and P-polarized light for the light of the first wavelength band, and reflecting the S-polarized light and transmitting the P-polarized light for the light of the second wavelength band and the light of the third wavelength band, and that synthesizes the pieces of light of the wavelength bands emitted from the first to third light modulation devices; and
a projection optical system that projects the light synthesized by the color synthesis device, wherein
full width at half maximum of a spectrum of the light of the first wavelength band that enters the color synthesis device is 40 nm or lower.

2. The projection-type display apparatus according to claim 1, further comprising:
a first polarization separation device that allows the pieces of light of the two wavelength bands of the first to third wavelength bands to enter, and that guides each of the pieces of light of the two wavelength bands to corresponding one of the first to third light modulation devices; and
a second polarization separation device that allows the piece of light of the other one wavelength band of the first to third wavelength bands to enter, and that guides the piece of light of the one wavelength band to corresponding one of the first to third light modulation devices.

3. The projection-type display apparatus according to claim 2, wherein the light of the first wavelength band and the light of the third wavelength band enter the first polarization separation device, and the light of the second wavelength band enters the second polarization separation device.

4. The projection-type display apparatus according to claim 3, wherein
the first polarization separation device guides to the color synthesis device the light modulated by the first and third light modulation devices, and
the second polarization separation device guides to the color separation device the light modulated by the second light modulation device.

5. The projection-type display apparatus according to claim 4, further comprising:
a first phase difference plate provided on an optical path between the first polarization separation device and the color synthesis device: and
a second phase difference plate provided on an optical path between the second polarization separation device and the color synthesis device.

6. The projection-type display apparatus according to claim 4, wherein no polarizing plate and wavelength selective phase difference plate are provided between the first polarization separation device and the color synthesis device and between the second polarization separation device and the color synthesis device.

7. The projection-type display apparatus according to claim 4, further comprising:
a color separation device that allows the pieces of light of the first to third wavelength bands emitted from the light source to enter, and that guides the pieces of light of the first wavelength band and the third wavelength band to the first polarization separation device and guides the piece of light of the second wavelength band to the second polarization separation device.

8. The projection-type display apparatus according to claim 7, further comprising:
a wavelength selective phase difference plate between the color separation device and the first polarization separation device, the wavelength selective phase difference plate selectively functioning on the light of the third wavelength band, of the pieces of light of the first wavelength band and the third wavelength band.

9. The projection-type display apparatus according to claim 7, wherein the color separation device includes a first light-entering surface that allows the piece of light of the third wavelength band to enter and a second light-entering surface that allows the pieces of light of the first wavelength band and the second wavelength band to enter.

10. The projection-type display apparatus according to claim 9, wherein the P-polarized light of the third wavelength band enters the first light-entering surface, and the S-polarized light of the piece of light of the first wavelength band enters the second light-entering surface.

11. The projection-type display apparatus according to claim 1, wherein the color synthesis device has the characteristic of transmitting both the S-polarized light and the P-polarized light for the piece of light of the first wavelength band.

12. The projection-type display apparatus according to claim 1, wherein the color synthesis device has the characteristic of reflecting both the S-polarized light and the P-polarized light for the light of the first wavelength band.

13. The projection-type display apparatus according to claim 1 comprising the one light source.

14. The projection-type display apparatus according to claim 13, wherein the one light source emits white light.

15. The projection-type display apparatus according to claim 1, wherein the first wavelength band is a blue band, the second wavelength band is a green band, and the third wavelength band is a red band.

16. The projection-type display apparatus according to claim 1, wherein the first to third light modulation devices are reflective-type light modulation devices.
